(19) United States
(12) Patent Application Publication
(10) Pub. No.: US 2026/0079331 A1
(43) Pub. Date: Mar. 19, 2026

(54) ULTRA SHORT THROW PROJECTION LENS

(71) Applicant: SUN YANG OPTICS DEVELOPMENT CO., LTD., Taoyuan City (TW)

(72) Inventors: Wei Hao HUANG, Taoyuan City (TW); Yu Hung CHOU, Taoyuan City (TW); Sheng Che WU, Taoyuan City (TW)

(21) Appl. No.: 18/884,754

(22) Filed: Sep. 13, 2024

(51) Int. Cl. G02B 13/16; G02B 13/18; G02B 13/24; G03B 21/14

(52) U.S. Cl. CPC G02B 13/16; G02B 13/18; G02B 13/24; G03B 21/147

(57) ABSTRACT

An ultra short throw projection lens sequentially comprising: a first lens group and a second lens group, the image source is first projected into an intermediate image by the second lens group, then the intermediate image is projected into a final image on the screen side by the first lens group, which complies with 0.23≤TR≤0.45 and 1.6≤|IMH2|/|IMH1|≤3, TR is the throw ratio of the ultra-short throw projection lens, IMH1 is the maximum image height of the image source, IMH2 is the maximum image height of the intermediate image, the second lens group includes an aperture, and the aperture has an F/# between 1.6˜3.2.

### BACKGROUND OF THE INVENTION

### 1. Field of the Invention

The present invention relates to an ultra short throw projection lens, particularly to one that meets the requirements of shortening the projection distance and taking into account the quality of projection imaging.

### 2. Description of the Related Art

Projectors continue to innovate with the advancement of technology, from general focal length projectors to short focal length projectors, which shows the value of projectors in the market. The projectors application includes multimedia information presentation systems, projection TVs, home cinemas, and video conferencing. However, in recent years, the short-throw projector market has been used in the education market and promote to small space home use.

The longer the focal length of the projection lens, the smaller the field of view. On the contrary, the shorter the focal length of the projection lens, the larger the field of view, and the stronger the distortion caused by the optical principle. Therefore, when the projection distance of a short throw projector is shortened, it does not guarantee the quality of projection imaging. Therefore, how to take into account the projection imaging quality and optimize the projection configuration even when the projection distance is shortened is a problem that the present invention intends to solve.

### SUMMARY OF THE INVENTION

A primary objective of the present invention is to provide an ultra short throw projection lens which meet the projection requirements of shortening the projection distance and taking into account the quality of projection imaging.

To achieve the objects mentioned above, the present invention a first lens group and a second lens group, the image source is first projected into an intermediate image by the second lens group, then the intermediate image is projected into a final image on the screen side by the first lens group, which complies with 0.23≤TR≤0.45 and 1.6≤|IMH2|/|IMH1|≤3, TR is the throw ratio of the ultra-short throw projection lens, IMH1 is the maximum image height of the image source, IMH2 is the maximum image height of the intermediate image, the second lens group includes an aperture, and the aperture has an F/# between 1.6˜3.2.

Also, the focal length of the first lens group is F1, which complies with 2.3≤F1/TR/|IMH1|≤3.5; the focal length of the second lens group is F2, which complies with 70≤|F2|≤300; the Vd of the last lens of the second lens group close to the image source is between 16˜25.

Also, the first lens group includes a first aspherical lens with a concave surface facing the image source side, and a second aspherical lens with a concave surface facing the imaging side, wherein the first aspherical lens is a convex-concave lens or a biconcave lens, complies with 1≤CA*TR/|IMH1|≤2.1, where CA is the effective diameter of the imaging side of the first aspherical lens; the second aspherical lens is a concave-convex lens or convex-concave lens.

Also, the ultra short throw projection lens complies with 6≤ASP*F/#≤10, where ASP is the total number of aspheric lenses of the ultra short throw projection lens; the ultra short throw projection lens complies with 110≤FOV≤155, and FOV is the maximum field of view angle of the ultra short throw projection lens; the ultra-short throw projection lens further includes a reflective element located between the first lens group and the second lens group for changing the direction of the optical axis.

### BRIEF DESCRIPTION OF THE DRAWINGS

FIG. 1A is a schematic diagram illustrating lenses arrangement of the first embodiment A of the present invention;

FIG. 1B is a schematic diagram illustrating lenses arrangement of the first embodiment B of the present invention;

FIG. 1C is a transverse ray fan diagram of the first embodiment A and first embodiment B of the present invention;

FIG. 1D is a field curve diagram of the first embodiment A and first embodiment B of the present invention;

FIG. 1E is a distortion diagram of the first embodiment A and first embodiment B of the present invention;

FIG. 1F is a lateral color aberration diagram of the first embodiment A and first embodiment B of the present invention;

FIG. 2A is a schematic diagram illustrating lenses arrangement of the second embodiment A of the present invention;

FIG. 2B is a schematic diagram illustrating lenses arrangement of the second embodiment B of the present invention;

FIG. 2C is a transverse ray fan diagram of the second embodiment A and second embodiment B of the present invention;

FIG. 2D is a field curve diagram of the second embodiment A and second embodiment B of the present invention;

FIG. 2E is a distortion diagram of the second embodiment A and second embodiment B of the present invention;

FIG. 2F is a lateral color aberration diagram of the second embodiment A and second embodiment B of the present invention;

FIG. 3A is a schematic diagram illustrating lenses arrangement of the third embodiment A of the present invention;

FIG. 3B is a schematic diagram illustrating lenses arrangement of the third embodiment B of the present invention;

FIG. 3C is a transverse ray fan diagram of the third embodiment A and third embodiment B of the present invention;

FIG. 3D is a field curve diagram of the third embodiment A and third embodiment B of the present invention;

FIG. 3E is a distortion diagram of the third embodiment A and third embodiment B of the present invention;

FIG. 3F is a lateral color aberration diagram of the third embodiment A and third embodiment B of the present invention.

### DETAILED DESCRIPTION OF THE PREFERRED EMBODIMENT

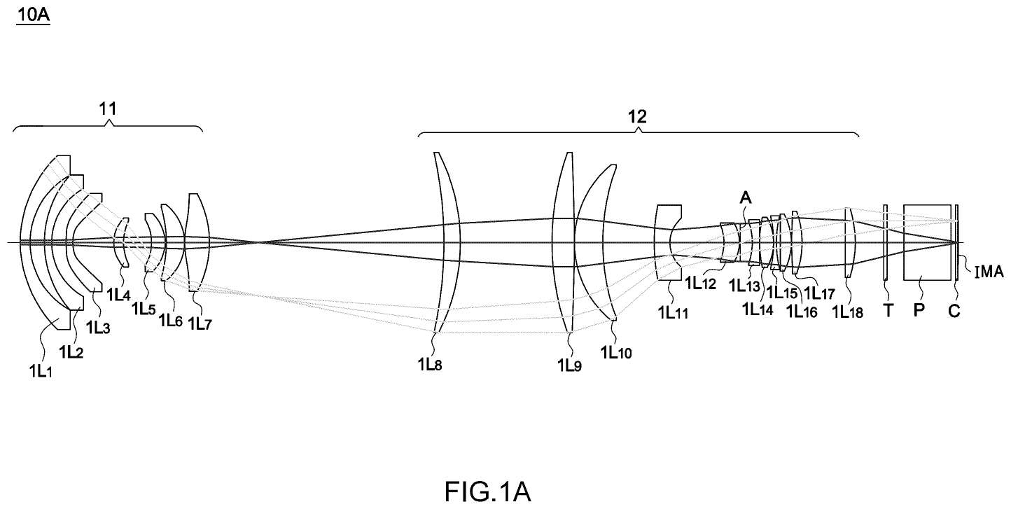

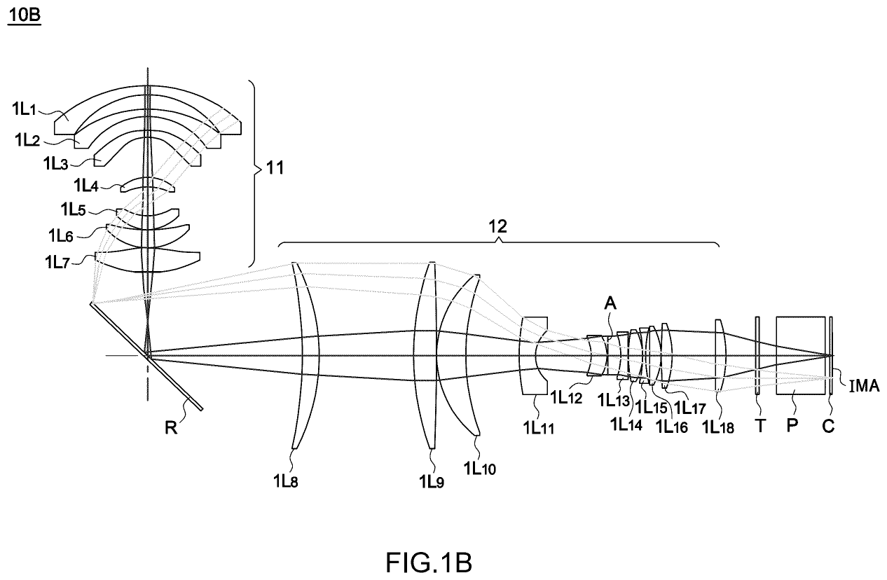

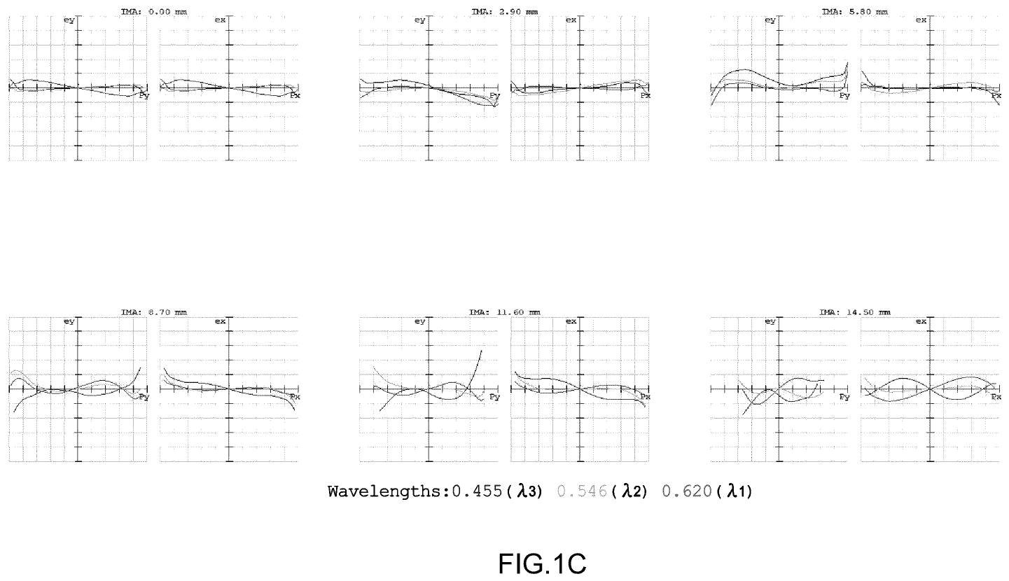

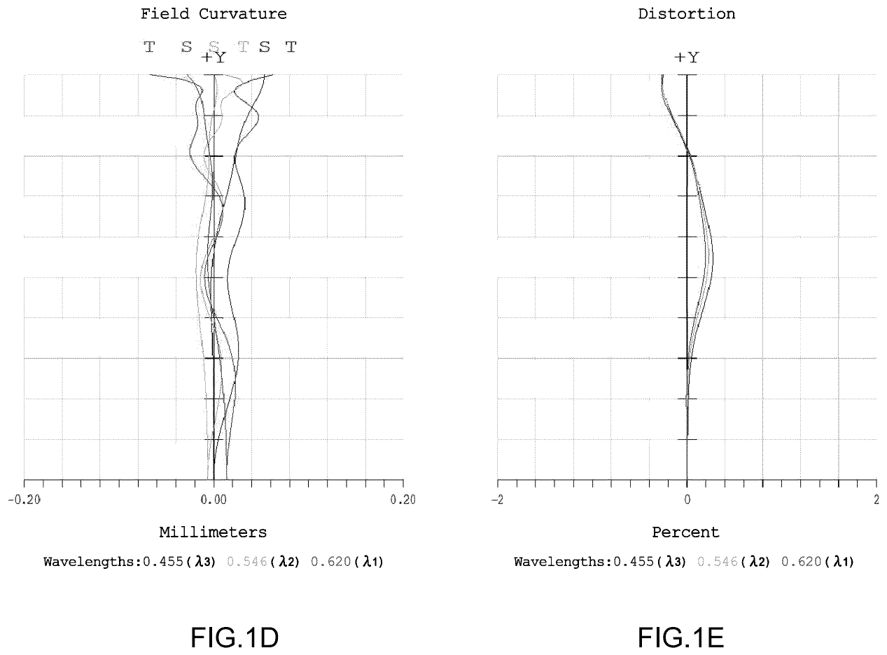

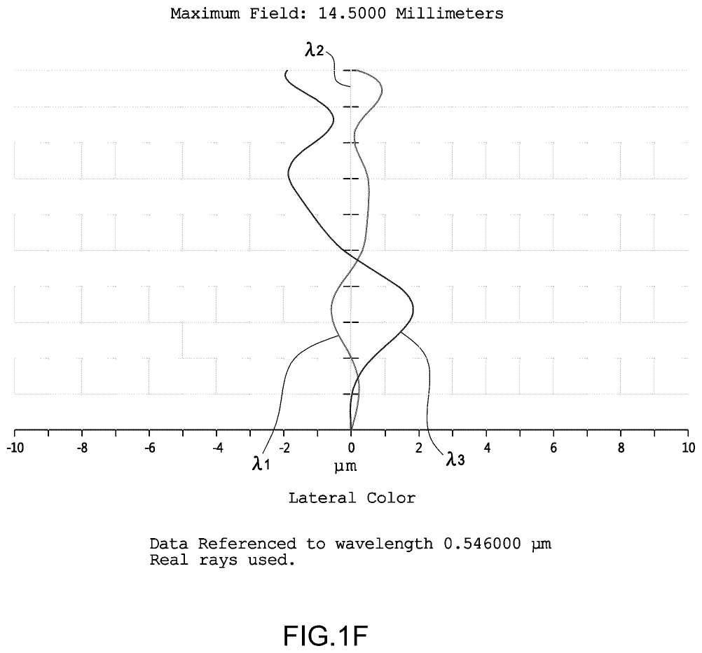

Referring to FIG. 1A, an ultra short throw projection lens 10A of the first embodiment 1A of the present invention includes: a first lens group 11, a second lens group 12 and a transmissive smooth picture actuator T, then a prism P, a cover glass C and an image source IMA are sequentially provided behind the transmissive smooth picture actuator T; in sequence from the imaging side to the image source side, the first lens group 11 has a first lens 1L1, a second lens 1L2, a third lens 1L3, a fourth lens 1L4, a fifth lens 1L5, and a sixth lens 1L6 and a seventh lens 1L7; in sequence from the imaging side to the image source side, the second lens group 12 has an eighth lens 1L8, a ninth lens 1L9, a tenth lens 1L10, an eleventh lens 1L11, a twelfth lens 1L12, an aperture A, a thirteenth lens 1L13, a fourteenth lens 1L14, a fifteenth lens 1L15, a sixteenth lens 1L16, a seventeenth lens 1L17 and an eighteenth lens 1L18, the aperture A has an F/#=2, the image source IMA is first projected into an intermediate image by the second lens group 12, then the intermediate image is projected into a final image on the screen side by the first lens group 11.

The throw ratio (TR) of the ultra short throw projection lens 10A=0.37, the maximum image height of the image source (|IMH1|)=14.5, the maximum image height of the intermediate image (|IMH2|)=35.74, |IMH2|/|IMH1|=2.5; The total number of aspherical lenses (ASP) of the ultra short throw projection lens 10A=4 (the third lens 1L3, the fifth lens 1L5, the seventh lens 1L7 and the twelfth lens 1L12), ASP*F/#=8; The maximum field of view (FOV) of this ultra short throw projection lens 10A=130.68.

The first lens group 11 has a focal length (F1)=16.9, F1/TR/|IMH1|=3.1. The first lens group 11 includes a first aspherical lens (the third lens 1L3) with a concave surface facing the image source side, and a second aspherical lens (the fifth lens 1L5) with a concave surface facing the imaging side, the first aspherical lens is a convex-concave lens, and the second aspherical lens is a convex-concave lens, the effective diameter (CA) of the imaging side of the first aspherical lens=66, CA*TR/|IMH1|=1.7; the second lens group 12 has a focal length (F2)=−130.7, the last lens of the second lens group 12 which is close to the image source side (the eighteenth lens 1L18) has Vd=17.94.

Referring to FIG. 1B, the differences between the ultra short throw projection lens 10B of embodiment 1B of the present invention and the ultra short throw projection lens 10A of embodiment 1A of the present invention is: the ultra short throw projection lens 10B further includes a reflective element R located between the first lens group 11 and the second lens group 12 for changing the direction of the optical axis.

The lens design parameters of the ultra short throw projection lenses 10A and 10B are as shown in Table 1A, Table 1B, and Table 1C; wherein, 1L1R1 is the imaging side surface (R1) of the first lens (1L1), and 1L1R2 is the image source side surface (R2) of the first lens (1L1), 1L2R1 is the imaging side surface (R1) of the second lens (1L2), 1L2R2 is the image source side surface (R2) of the second lens (1L2), . . . 1L18R1 is the imaging side surface (R1) of the eighteenth lens (1L18), 1L18R2 is the image source side surface (R2) of the eighteenth lens 1L18), and so on.

TABLE 1
A

| Comment | Radius | Thickness | Nd | Vd |
|---|---|---|---|---|
| 1L1R1 | 82.37 | 6.00 | 1.80 | 46.57 |
| 1L1R2 | 52.75 | 9.38 | | |
| 1L2R1 | 69.85 | 4.60 | 1.80 | 46.57 |
| 1L2R2 | 42.03 | 9.27 | | |
| 1L3R1 | 136.86 | 4.20 | 1.52 | 64.07 |
| 1L3R2 | 24.88 | 26.36 | | |
| 1L4R1 | 23.97 | 6.14 | 1.83 | 42.73 |
| 1L4R2 | 35.16 | 18.15 | | |
| 1L5R1 | −20.58 | 8.84 | 1.59 | 59.01 |
| 1L5R2 | −26.00 | 0.51 | | |
| 1L6R1 | −88.48 | 11.53 | 1.50 | 81.61 |
| 1L6R2 | −32.83 | 0.20 | | |
| 1L7R1 | 38.23 | 15.75 | 1.59 | 59.01 |
| 1L7R2 | −193.47 | 150.00 | | |
| 1L8R1 | −291.26 | 10.42 | 1.80 | 46.57 |
| 1L8R2 | −136.48 | 58.83 | | |
| 1L9R1 | 189.30 | 14.23 | 1.80 | 46.57 |
| 1L9R2 | −1318.28 | 0.20 | | |
| 1L10R1 | 69.12 | 17.96 | 1.80 | 46.57 |
| 1L10R2 | 151.59 | 32.90 | | |
| 1L11R1 | 150.00 | 10.00 | 1.62 | 60.34 |
| 1L11R2 | 21.37 | 34.50 | | |
| 1L12R1 | −33.60 | 10.00 | 1.52 | 64.07 |
| 1L12R2 | −24.37 | 0.58 | | |
| APERTURE | INF | 8.14 | | |
| 1L13R1 | −38.29 | 4.30 | 1.85 | 23.78 |
| 1L13R2 | −643.87 | 0.20 | | |
| 1L14R1 | 100.65 | 8.70 | 1.52 | 64.20 |
| 1L14R2 | −35.41 | 0.20 | | |
| 1L15R1 | −76.07 | 1.80 | 1.85 | 23.78 |
| 1L15R2 | 85.98 | 2.05 | | |
| 1L16R1 | INF | 7.29 | 1.50 | 81.61 |
| 1L16R2 | −40.96 | 0.20 | | |
| 1L17R1 | 333.15 | 6.72 | 1.50 | 81.61 |
| 1L17R2 | −62.98 | 27.55 | | |
| 1L18R1 | INF | 6.50 | 1.95 | 17.94 |
| 1L18R2 | −78.05 | 18.19 | | |

B

| ASPH | 1L3R1 | 1L3R2 | 1L5R1 | 1L5R2 |
|---|---|---|---|---|
| Radius | 136.86 | 24.88 | −20.58 | −26.00 |
| Conic | 2.70 | −0.34 | −2.18 | −1.19 |
| 4TH | 4.72E−05 | 4.29E−05 | 1.15E−05 | −5.95E−05 |
| 6TH | −1.08E−07 | −2.12E−08 | 2.23E−07 | 4.07E−07 |
| 8TH | 1.67E−10 | −4.69E−10 | −2.86E−09 | −1.74E−09 |
| 10th | −1.81E−13 | 1.54E−12 | 2.05E−11 | 4.00E−12 |
| 12th | 1.36E−16 | −2.35E−15 | −8.65E−14 | −1.52E−15 |
| 14th | −6.29E−20 | 1.80E−18 | 1.93E−16 | −9.14E−18 |
| 16th | 1.31E−23 | −5.61E−22 | −1.82E−19 | 1.06E−20 |

C

| ASPH | 1L7R1 | 1L7R2 | 1L12R1 | 1L12R2 |
|---|---|---|---|---|
| Radius | 38.23 | −193.47 | −33.60 | −24.37 |
| Conic | −3.56 | 30.10 | 0.03 | −1.42 |
| 4TH | −3.97E−05 | −2.27E−05 | 2.52E−07 | −3.54E−06 |
| 6TH | 1.30E−07 | 4.61E−08 | 2.49E−08 | 1.50E−08 |
| 8TH | −2.60E−10 | −3.03E−11 | −3.87E−10 | −2.55E−10 |
| 10th | 3.21E−13 | −3.50E−14 | 6.20E−12 | 3.60E−12 |
| 12th | −2.41E−16 | 7.95E−17 | −5.13E−14 | −2.66E−14 |
| 14th | 1.01E−19 | −5.61E−20 | 2.25E−16 | 1.03E−16 |
| 16th | −1.81E−23 | 1.46E−23 | −3.98E−19 | −1.62E−19 |

TABLE 1B

| ASPH | 1L3R1 | 1L3R2 | 1L5R1 | 1L5R2 |
|---|---|---|---|---|
| Radius | 136.86 | 24.88 | −20.58 | −26.00 |
| Conic | 2.70 | −0.34 | −2.18 | −1.19 |
| 4TH | 4.72E−05 | 4.29E−05 | 1.15E−05 | −5.95E−05 |
| 6TH | −1.08E−07 | −2.12E−08 | 2.23E−07 | 4.07E−07 |
| 8TH | 1.67E−10 | −4.69E−10 | −2.86E−09 | −1.74E−09 |
| 10th | −1.81E−13 | 1.54E−12 | 2.05E−11 | 4.00E−12 |
| 12th | 1.36E−16 | −2.35E−15 | −8.65E−14 | −1.52E−15 |
| 14th | −6.29E−20 | 1.80E−18 | 1.93E−16 | −9.14E−18 |
| 16th | 1.31E−23 | −5.61E−22 | −1.82E−19 | 1.06E−20 |

TABLE 1C

| ASPH | 1L7R1 | 1L7R2 | 1L12R1 | 1L12R2 |
|---|---|---|---|---|
| Radius | 38.23 | −193.47 | −33.60 | −24.37 |
| Conic | −3.56 | 30.10 | 0.03 | −1.42 |
| 4TH | −3.97E−05 | −2.27E−05 | 2.52E−07 | −3.54E−06 |
| 6TH | 1.30E−07 | 4.61E−08 | 2.49E−08 | 1.50E−08 |
| 8TH | −2.60E−10 | −3.03E−11 | −3.87E−10 | −2.55E−10 |
| 10th | 3.21E−13 | −3.50E−14 | 6.20E−12 | 3.60E−12 |
| 12th | −2.41E−16 | 7.95E−17 | −5.13E−14 | −2.66E−14 |
| 14th | 1.01E−19 | −5.61E−20 | 2.25E−16 | 1.03E−16 |
| 16th | −1.81E−23 | 1.46E−23 | −3.98E−19 | −1.62E−19 |

The ultra short throw projection lens 10A and 10B uses a first wavelength λ1 of 620 nm, a second wavelength λ2 of 546 nm and a third wavelength λ3 of 455 nm to simulate different transverse ray fan plot as shown in FIG. 1C, and the image source IMA presents different image heights of 0.00 mm, 2.90 mm, 5.80 mm, 8.70 mm, 11.60 mm and 14.50 mm respectively. The symbols ey, py, ex and px respectively represent the y-axis lateral aberration, y-axis pupil height, X-axis lateral aberration, x-axis pupil height, wherein maximum scale is ±20.000 um, the generated aberration value is controlled within the range of −8 um˜12 um; The field curvature diagram in FIG. 1D has a maximum field of view of 65.333 degrees, curves T and S are respectively the tangential field curvature characteristic curve and the sagittal field curvature characteristic curve, the tangential field curvature value and sagittal field curvature value are controlled within the range of −0.08 mm˜0.08 mm; The distortion diagram in FIG. 1E has a maximum field of view of 65.333 degrees, and the distortion amount is controlled within the range of −0.4˜0.4%; The lateral color aberration diagram in FIG. 1F has a maximum field of view of 14.5000 mm, and using a wavelength of about 0.546 microns as a reference, the lateral color aberration value is controlled within the range of −2.0 um˜2.0 um.

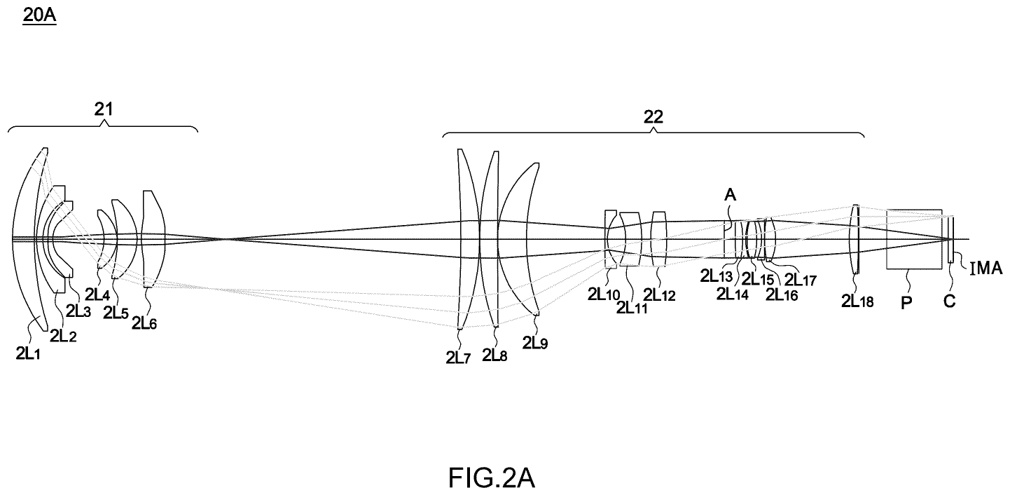

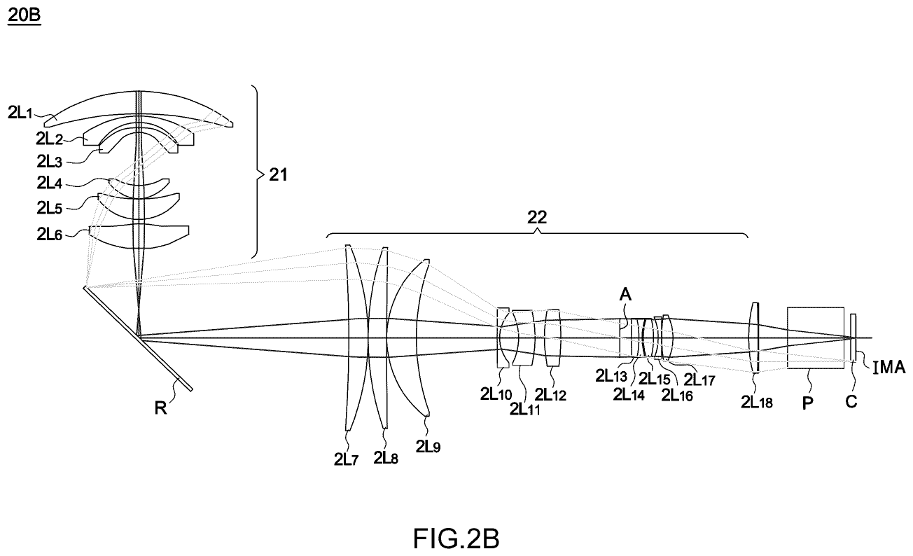

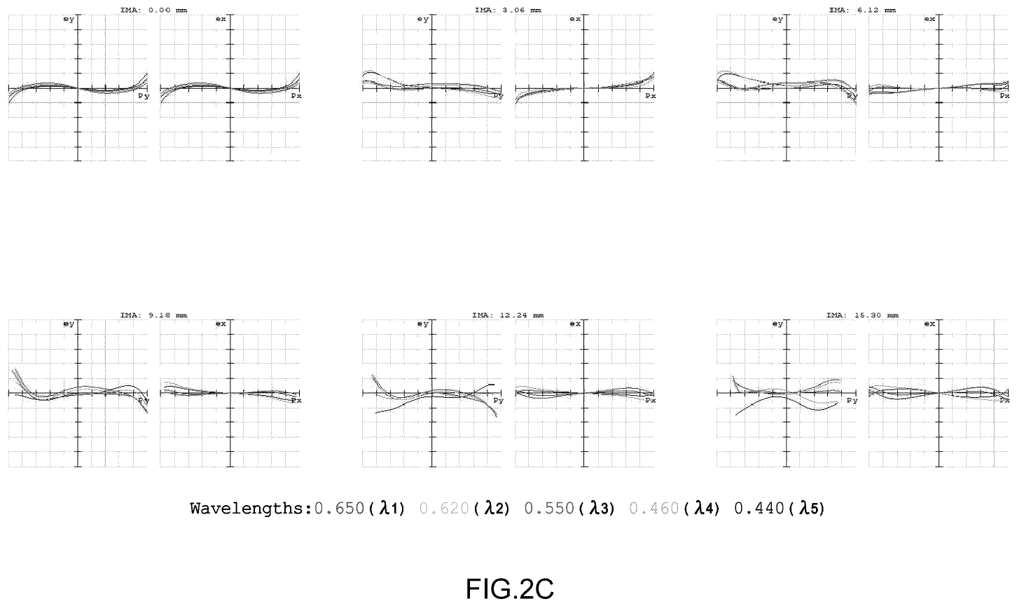

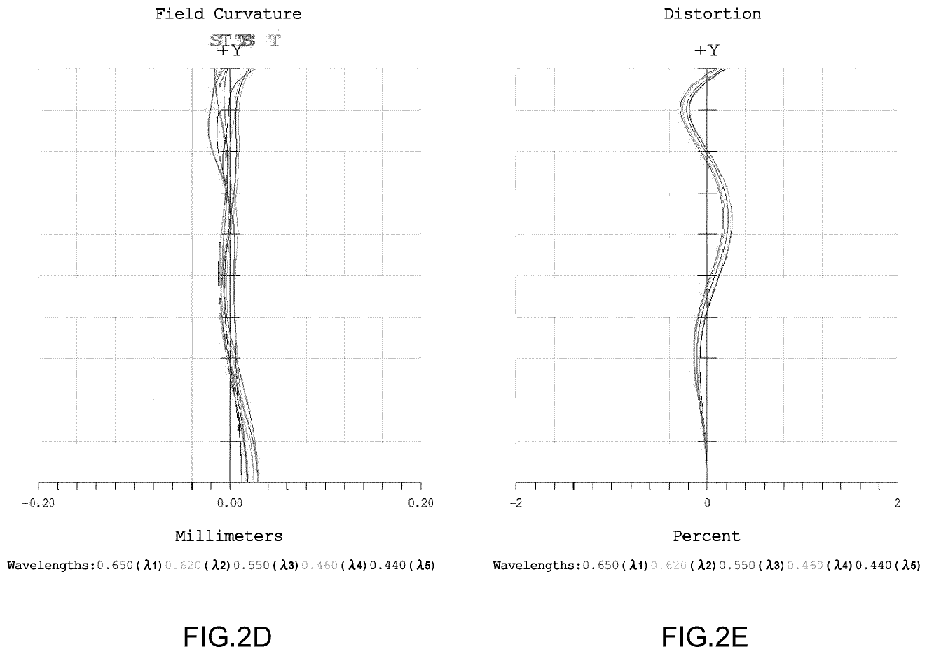

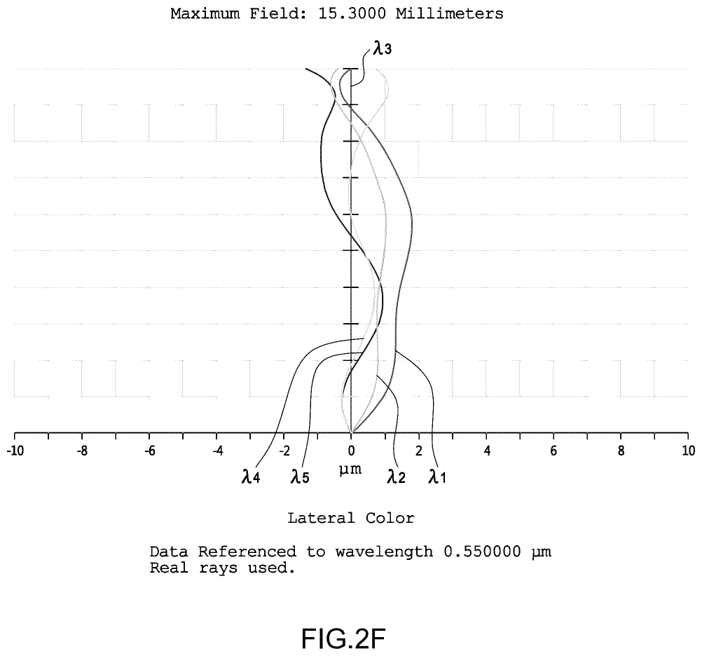

Referring to FIG. 2A, an ultra short throw projection lens 20A of the first embodiment 1A of the present invention includes: a first lens group 21, a second lens group 22 and a transmissive smooth picture actuator T, then a prism P, a cover glass C and an image source IMA are sequentially provided behind the transmissive smooth picture actuator T; in sequence from the imaging side to the image source side, the first lens group 21 has a first lens 2L1, a second lens 2L2, a third lens 2L3, a fourth lens 2L4, a fifth lens 2L5 and a sixth lens 2L6; in sequence from the imaging side to the image source side, the second lens group 22 has a seventh lens 2L7, an eighth lens 2L8, a ninth lens 2L9, a tenth lens 2L10, an eleventh lens 2L11, a twelfth lens 2L12, an aperture A, a thirteenth lens 2L13, a fourteenth lens 2L14, a fifteenth lens 2L15, a sixteenth lens 2L16, a seventeenth lens 2L17 and an eighteenth lens 2L18, the aperture A has an F/#=2.8, the image source IMA is first projected into an intermediate image by the second lens group 22, then the intermediate image is projected into a final image on the screen side by the first lens group 21.

The throw ratio (TR) of the ultra short throw projection lens 20A=0.37, the maximum image height of the image source (|IMH1|)=15.4, the maximum image height of the intermediate image (|IMH2|)=34.34, |IMH2|/|IMH1|=2.2; The total number of aspherical lenses (ASP) of the ultra short throw projection lens 20A=3 (the third lens 2L3, the fourth lens 2L4 and the sixth lens 2L6), ASP*F/#=8.4; The maximum field of view (FOV) of this ultra short throw projection lens 20A=122.22.

The first lens group 21 has a focal length (F1)=18.4, F1/TR/|IMH1|=3.2. The first lens group 21 includes a first aspherical lens (the third lens 2L3) with a concave surface facing the image source side, and a second aspherical lens (the fourth lens 2L4) with a concave surface facing the imaging side, the first aspherical lens is a convex-concave lens, and the second aspherical lens is a convex-concave lens, the effective diameter (CA) of the imaging side of the first aspherical lens=51.6, CA*TR/|IMH1|=1.2; the second lens group 22 has a focal length (F2)=−203.5, the last lens of the second lens group 22 which is close to the image source side (the eighteenth lens 2L18) has Vd=17.94.

Referring to FIG. 2B, the differences between the ultra short throw projection lens 20B of embodiment 2B of the present invention and the ultra short throw projection lens 20A of embodiment 2A of the present invention is: the ultra short throw projection lens 20B further includes a reflective element R located between the first lens group 21 and the second lens group 22 for changing the direction of the optical axis.

The lens design parameters of the ultra short throw projection lenses 20A and 20B are as shown in Table 2A, Table 2B, and Table 2C; wherein, 2L1R1 is the imaging side surface (R1) of the first lens (2L1), and 2L1R2 is the image source side surface (R2) of the first lens (2L1), 2L2R1 is the imaging side surface (R1) of the second lens (2L2), 2L2R2 is the image source side surface (R2) of the second lens (2L2), . . . 2L18R1 is the imaging side surface (R1) of the eighteenth lens (2L18), 2L18R2 is the image source side surface (R2) of the eighteenth lens (2L18), and so on.

TABLE 2
A

| Comment | Radius | Thickness | Nd | Vd |
|---|---|---|---|---|
| 2L1R1 | 105.67 | 14.02 | 1.52 | 64.20 |
| 2L1R2 | 208.86 | 1.28 | | |
| 2L2R1 | 63.86 | 4.00 | 1.90 | 31.42 |
| 2L2R2 | 31.12 | 3.24 | | |
| 2L3R1 | 91.99 | 3.10 | 1.52 | 64.06 |
| 2L3R2 | 19.00 | 32.88 | | |
| 2L4R1 | −27.99 | 8.11 | 1.58 | 59.42 |
| 2L4R2 | −27.91 | 0.20 | | |
| 2L5R1 | −94.50 | 12.56 | 1.59 | 68.34 |
| 2L5R2 | −34.14 | 2.85 | | |
| 2L6R1 | 39.41 | 15.08 | 1.58 | 59.42 |
| 2L6R2 | −200.00 | 188.84 | | |
| 2L7R1 | −775.90 | 11.59 | 1.80 | 46.57 |
| 2L7R2 | −168.19 | 0.20 | | |
| 2L8R1 | 191.85 | 11.21 | 1.80 | 46.57 |
| 2L8R2 | 2786.63 | 0.20 | | |
| 2L9R1 | 66.19 | 18.57 | 1.49 | 70.44 |
| 2L9R2 | 159.98 | 49.52 | | |
| 2L10R1 | 286.49 | 1.80 | 1.77 | 49.61 |
| 2L10R2 | 26.85 | 11.80 | | |
| 2L11R1 | −38.40 | 10.00 | 1.49 | 70.44 |
| 2L11R2 | −90.21 | 5.94 | | |
| 2L12R1 | 96.50 | 10.00 | 1.85 | 23.79 |
| 2L12R2 | −180.52 | 36.82 | | |
| APERTURE | INF | 6.77 | | |
| 2L13R1 | 119.62 | 4.88 | 1.69 | 54.54 |
| 2L13R2 | −60.43 | 0.20 | | |
| 2L14R1 | −81.54 | 1.80 | 1.73 | 28.32 |
| 2L14R2 | 43.30 | 0.81 | | |
| 2L15R1 | 59.20 | 6.16 | 1.59 | 68.34 |
| 2L15R2 | −50.38 | 3.08 | | |
| 2L16R1 | −34.11 | 1.80 | 1.73 | 28.32 |
| 2L16R2 | 522.48 | 0.20 | | |
| 2L17R1 | 103.46 | 7.06 | 1.44 | 94.52 |
| 2L17R2 | −37.76 | 46.90 | | |
| 2L18R1 | 91.43 | 5.83 | 1.95 | 17.94 |
| 2L18R2 | −596.62 | 0.22 | | |

B

| Comment | Radius | Thickness | Nd | Vd |
|---|---|---|---|---|
| 2L1R1 | 105.67 | 14.02 | 1.52 | 64.20 |
| 2L1R2 | 208.86 | 1.28 | | |
| 2L2R1 | 63.86 | 4.00 | 1.90 | 31.42 |
| 2L2R2 | 31.12 | 3.24 | | |
| 2L3R1 | 91.99 | 3.10 | 1.52 | 64.06 |
| 2L3R2 | 19.00 | 32.88 | | |
| 2L4R1 | −27.99 | 8.11 | 1.58 | 59.42 |
| 2L4R2 | −27.91 | 0.20 | | |
| 2L5R1 | −94.50 | 12.56 | 1.59 | 68.34 |
| 2L5R2 | −34.14 | 2.85 | | |
| 2L6R1 | 39.41 | 15.08 | 1.58 | 59.42 |
| 2L6R2 | −200.00 | 188.84 | | |
| 2L7R1 | −775.90 | 11.59 | 1.80 | 46.57 |
| 2L7R2 | −168.19 | 0.20 | | |
| 2L8R1 | 191.85 | 11.21 | 1.80 | 46.57 |
| 2L8R2 | 2786.63 | 0.20 | | |
| 2L9R1 | 66.19 | 18.57 | 1.49 | 70.44 |
| 2L9R2 | 159.98 | 49.52 | | |
| 2L10R1 | 286.49 | 1.80 | 1.77 | 49.61 |
| 2L10R2 | 26.85 | 11.80 | | |
| 2L11R1 | −38.40 | 10.00 | 1.49 | 70.44 |
| 2L11R2 | −90.21 | 5.94 | | |
| 2L12R1 | 96.50 | 10.00 | 1.85 | 23.79 |
| 2L12R2 | −180.52 | 36.82 | | |
| APERTURE | INF | 6.77 | | |
| 2L13R1 | 119.62 | 4.88 | 1.69 | 54.54 |
| 2L13R2 | −60.43 | 0.20 | | |
| 2L14R1 | −81.54 | 1.80 | 1.73 | 28.32 |
| 2L14R2 | 43.30 | 0.81 | | |
| 2L15R1 | 59.20 | 6.16 | 1.59 | 68.34 |
| 2L15R2 | −50.38 | 3.08 | | |
| 2L16R1 | −34.11 | 1.80 | 1.73 | 28.32 |
| 2L16R2 | 522.48 | 0.20 | | |
| 2L17R1 | 103.46 | 7.06 | 1.44 | 94.52 |
| 2L17R2 | −37.76 | 46.90 | | |
| 2L18R1 | 91.43 | 5.83 | 1.95 | 17.94 |
| 2L18R2 | −596.62 | 0.22 | | |

C

| Comment | Radius | Thickness | Nd | Vd |
|---|---|---|---|---|
| 2L1R1 | 105.67 | 14.02 | 1.52 | 64.20 |
| 2L1R2 | 208.86 | 1.28 | | |
| 2L2R1 | 63.86 | 4.00 | 1.90 | 31.42 |
| 2L2R2 | 31.12 | 3.24 | | |
| 2L3R1 | 91.99 | 3.10 | 1.52 | 64.06 |
| 2L3R2 | 19.00 | 32.88 | | |
| 2L4R1 | −27.99 | 8.11 | 1.58 | 59.42 |
| 2L4R2 | −27.91 | 0.20 | | |
| 2L5R1 | −94.50 | 12.56 | 1.59 | 68.34 |
| 2L5R2 | −34.14 | 2.85 | | |
| 2L6R1 | 39.41 | 15.08 | 1.58 | 59.42 |
| 2L6R2 | −200.00 | 188.84 | | |
| 2L7R1 | −775.90 | 11.59 | 1.80 | 46.57 |
| 2L7R2 | −168.19 | 0.20 | | |
| 2L8R1 | 191.85 | 11.21 | 1.80 | 46.57 |
| 2L8R2 | 2786.63 | 0.20 | | |
| 2L9R1 | 66.19 | 18.57 | 1.49 | 70.44 |
| 2L9R2 | 159.98 | 49.52 | | |
| 2L10R1 | 286.49 | 1.80 | 1.77 | 49.61 |
| 2L10R2 | 26.85 | 11.80 | | |
| 2L11R1 | −38.40 | 10.00 | 1.49 | 70.44 |
| 2L11R2 | −90.21 | 5.94 | | |
| 2L12R1 | 96.50 | 10.00 | 1.85 | 23.79 |
| 2L12R2 | −180.52 | 36.82 | | |
| APERTURE | INF | 6.77 | | |
| 2L13R1 | 119.62 | 4.88 | 1.69 | 54.54 |
| 2L13R2 | −60.43 | 0.20 | | |
| 2L14R1 | −81.54 | 1.80 | 1.73 | 28.32 |
| 2L14R2 | 43.30 | 0.81 | | |
| 2L15R1 | 59.20 | 6.16 | 1.59 | 68.34 |
| 2L15R2 | −50.38 | 3.08 | | |
| 2L16R1 | −34.11 | 1.80 | 1.73 | 28.32 |
| 2L16R2 | 522.48 | 0.20 | | |
| 2L17R1 | 103.46 | 7.06 | 1.44 | 94.52 |
| 2L17R2 | −37.76 | 46.90 | | |
| 2L18R1 | 91.43 | 5.83 | 1.95 | 17.94 |
| 2L18R2 | −596.62 | 0.22 | | |

The ultra short throw projection lens 20A and 20B uses a first wavelength λ1 of 650 nm, a second wavelength λ2 of 620 nm, a third wavelength λ3 of 550 nm, a fourth wavelength λ4 of 460 nm and a fifth wavelength λ3 of 440 nm to simulate different transverse ray fan plot as shown in FIG. 2C, and the image source IMA presents different image heights of 0.00 mm, 3.06 mm, 6.12 mm, 9.18 mm, 12.24 mm and 15.30 mm respectively. The symbols ey, py, ex and px respectively represent the y-axis lateral aberration, y-axis pupil height, X-axis lateral aberration, x-axis pupil height, wherein maximum scale is ±20.000 um, the generated aberration value is controlled within the range of −8 um˜8 um; The field curvature diagram in FIG. 2D has a maximum field of view of 65.958 degrees, curves T and S are respectively the tangential field curvature characteristic curve and the sagittal field curvature characteristic curve, the tangential field curvature value and sagittal field curvature value are controlled within the range of −0.04 mm˜0.04 mm; The distortion diagram in FIG. 2E has a maximum field of view of 65.958 degrees, and the distortion amount is controlled within the range of −0.4˜0.4%; The lateral color aberration diagram in FIG. 2F has a maximum field of view of 15.3000 mm, and using a wavelength of about 0.55 microns as a reference, the lateral color aberration value is controlled within the range of −2.0 um˜2.0 um.

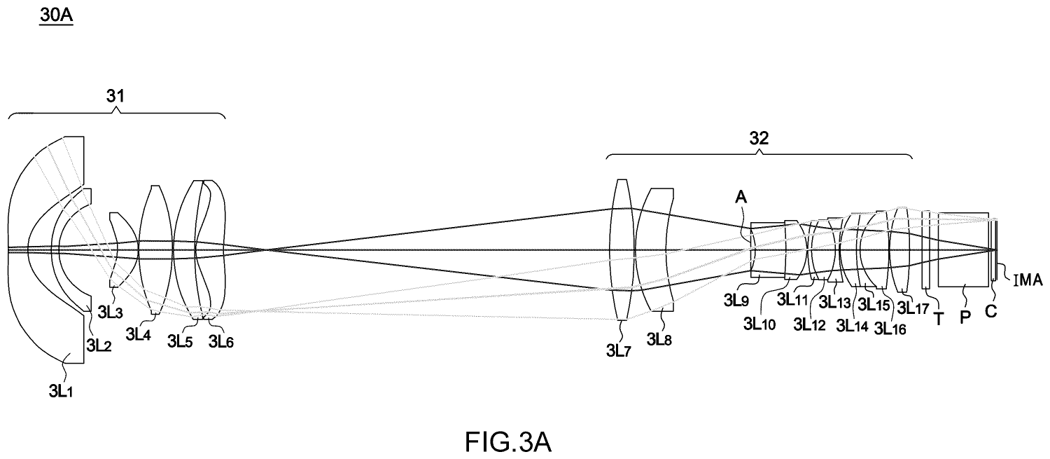

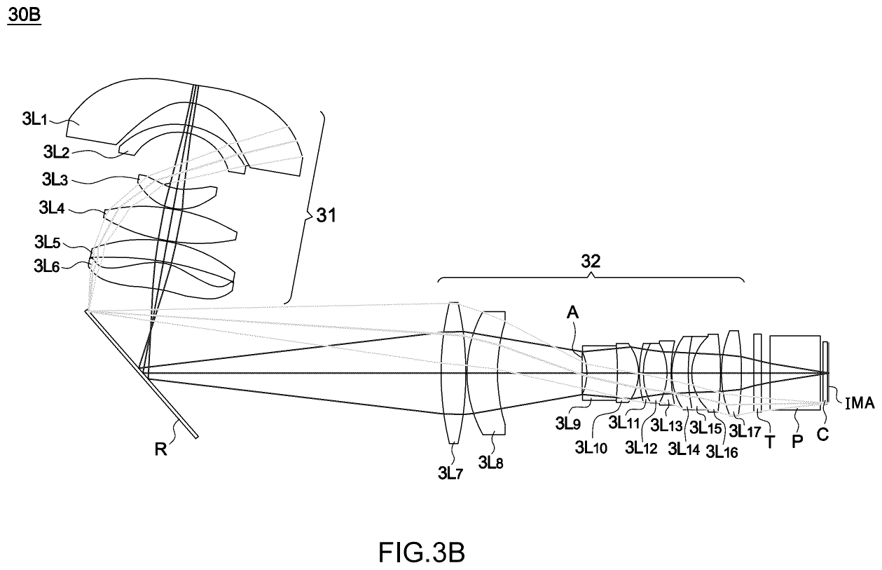

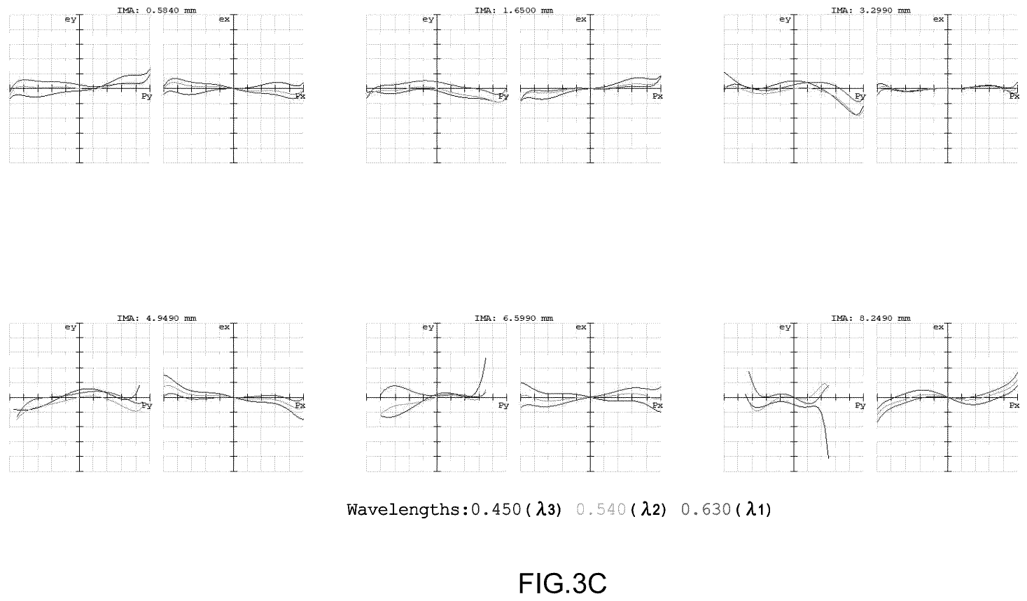

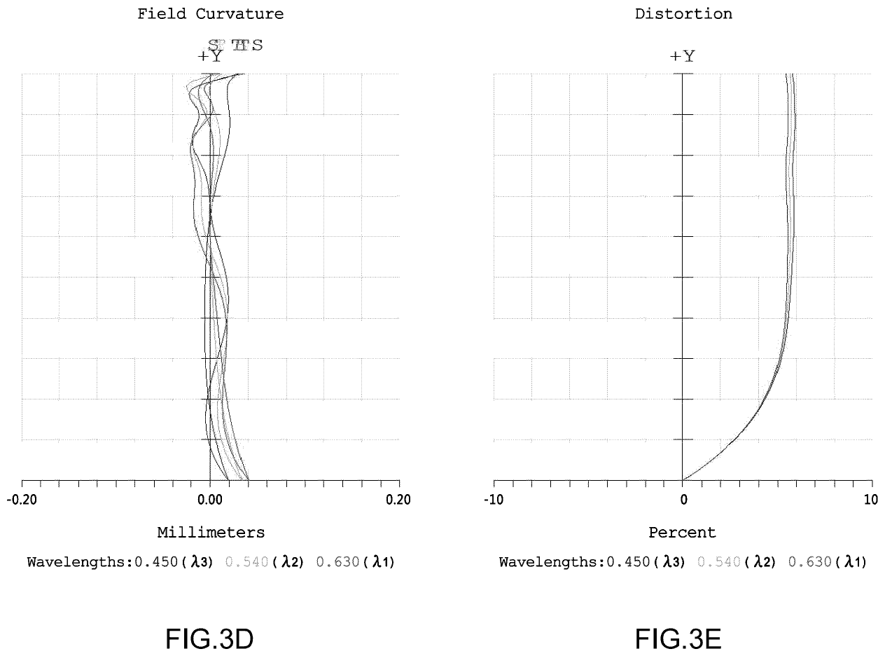

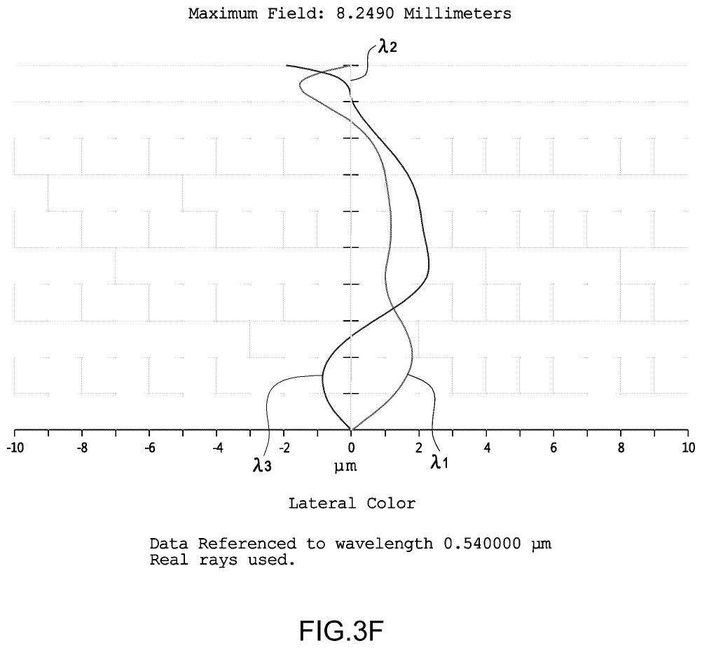

Referring to FIG. 3A, an ultra short throw projection lens 30A of the first embodiment 3A of the present invention includes: a first lens group 31, a second lens group 32 and a transmissive smooth picture actuator T, then a prism P, a cover glass C and an image source IMA are sequentially provided behind the transmissive smooth picture actuator T; in sequence from the imaging side to the image source side, the first lens group 31 has a first lens 3L1, a second lens 3L2, a third lens 3L3, a fourth lens 3L4, a fifth lens 3L5 and a sixth lens 3L6; in sequence from the imaging side to the image source side, the second lens group 32 has a seventh lens 3L7, an eighth lens 3L8, an aperture A, a ninth lens 3L9, a tenth lens 3L10, an eleventh lens 3L11, a twelfth lens 3L12, a thirteenth lens 3L13, a fourteenth lens 3L14, a fifteenth lens 3L15, a sixteenth lens 3L16 and a seventeenth lens 3L17, the aperture A has an F/#=1.9, the image source IMA is first projected into an intermediate image by the second lens group 32, then the intermediate image is projected into a final image on the screen side by the first lens group 31.

The throw ratio (TR) of the ultra short throw projection lens 30A=0.25, the maximum image height of the image source (|IMH1|)=8.25, the maximum image height of the intermediate image (|IMH2|)=16.92, |IMH2|/|IMH1|=2.1; The total number of aspherical lenses (ASP) of the ultra short throw projection lens 30A=4 (the first lens 3L1, the third lens 3L3, the sixth lens 3L6 and the tenth lens 3L10), ASP*F/#=7.6; The maximum field of view (FOV) of this ultra short throw projection lens 30A=143.8.

The first lens group 31 has a focal length (F1)=5.4, F1/TR/|IMH1|=2.6. The first lens group 31 includes a first aspherical lens (the first lens 3L1) with a concave surface facing the image source side, and a second aspherical lens (the third lens 3L3) with a concave surface facing the imaging side, the first aspherical lens is a biconcave lens, and the second aspherical lens is a concave-convex lens, the effective diameter (CA) of the imaging side of the first aspherical lens=62.3, CA*TR/|IMH1|=1.9; the second lens group 32 has a focal length (F2)=102.0, the last lens of the second lens group 32 which is close to the image source side (the seventeenth lens 3L17) has Vd=18.90.

Referring to FIG. 3B, the differences between the ultra short throw projection lens 30B of embodiment 3B of the present invention and the ultra short throw projection lens 30A of embodiment 3A of the present invention is: the ultra short throw projection lens 30B further includes a reflective element R located between the first lens group 31 and the second lens group 32 for changing the direction of the optical axis.

The lens design parameters of the ultra short throw projection lenses 30A and 30B are as shown in Table 3A, Table 3B, Table 3C and Table 3D; wherein, 3L1R1 is the imaging side surface (R1) of the first lens (3L1), and 3L1R2 is the image source side surface (R2) of the first lens (3L1), 3L2R1 is the imaging side surface (R1) of the second lens (3L2), 3L2R2 is the image source side surface (R2) of the second lens (3L2), . . . 3L17R1 is the imaging side surface (R1) of the seventeenth lens (3L17), 3L18R2 is the image source side surface (R2) of the seventeenth lens (3L17) and so on.

TABLE 3
A

| Comment | Radius | Thickness | Nd | Vd |
|---|---|---|---|---|
| 3L1R1 | −38.79 | 5.00 | 1.53 | 56.28 |
| 3L1R2 | 12.68 | 6.25 | | |
| 3L2R1 | 20.59 | 2.00 | 1.92 | 18.90 |
| 3L2R2 | 13.60 | 15.48 | | |
| 3L3R1 | −11.30 | 5.46 | 1.69 | 52.65 |
| 3L3R2 | −12.01 | 0.20 | | |
| 3L4R1 | 46.03 | 8.88 | 1.50 | 81.59 |
| 3L4R2 | −46.03 | 0.20 | | |
| 3L5R1 | 36.91 | 5.57 | 1.85 | 23.79 |
| 3L5R2 | 84.40 | 0.38 | | |
| 3L6R1 | 11.91 | 7.20 | 1.53 | 56.28 |
| 3L6R2 | 28.68 | 101.85 | | |
| 3L7R1 | 88.32 | 6.50 | 1.77 | 49.61 |
| 3L7R2 | −88.32 | 0.20 | | |
| 3L8R1 | 36.00 | 8.00 | 1.85 | 23.79 |
| 3L8R2 | 49.65 | 22.20 | | |
| APERTURE | INF | 1.30 | | |
| 3L9R1 | −15.28 | 8.00 | 1.83 | 37.23 |
| 3L10R1 | −97.90 | 5.55 | 1.51 | 63.90 |
| 3L10R2 | −12.89 | 0.20 | | |
| 3L11R1 | 32.49 | 1.00 | 1.85 | 23.79 |
| 3L12R1 | 18.18 | 6.25 | 1.50 | 81.59 |
| 3L13R1 | −18.18 | 1.00 | 1.81 | 25.48 |
| 3L13R2 | 37.03 | 0.20 | | |
| 3L14R1 | 17.75 | 4.28 | 1.50 | 81.59 |
| 3L15R1 | 49.08 | 1.00 | 1.81 | 25.48 |
| 3L16R1 | 13.84 | 7.58 | 1.50 | 81.59 |
| 3L16R2 | −79.84 | 0.20 | | |
| 3L17R1 | 33.66 | 5.22 | 1.92 | 18.90 |
| 3L17R2 | −85.20 | 3.35 | | |

B

| ASPH | 3L1R1 | 3L1R2 |
|---|---|---|
| Radius | −38.79 | 12.68 |
| Conic | — | −0.79 |
| 3TH | 1.74E−03 | 5.80E−04 |
| 4TH | −4.54E−05 | 8.86E−06 |
| 5TH | 2.81E−07 | −3.42E−07 |
| 6TH | 9.58E−09 | −9.58E−08 |
| 7TH | 2.27E−10 | 9.95E−10 |
| 8TH | 2.14E−12 | 3.54E−10 |
| 9TH | −9.49E−14 | −1.58E−11 |
| 10TH | −1.19E−14 | −1.33E−12 |
| 11TH | 4.74E−17 | 6.73E−15 |
| 12TH | 8.30E−18 | 2.40E−15 |

C

| ASPH | 3L3R1 | 3L3R2 | 3L6R1 | 3L6R2 |
|---|---|---|---|---|
| Radius | −11.30 | −12.01 | 11.91 | 28.68 |
| Conic | −0.63 | −0.70 | −0.67 | 0.00 |
| 4TH | 4.01E−04 | −1.50E−04 | −2.23E−04 | −2.06E−04 |
| 6TH | −3.26E−06 | 1.03E−06 | 6.92E−07 | 9.79E−07 |
| 8TH | 2.27E−08 | 1.06E−10 | −1.70E−09 | −2.45E−09 |
| 10th | −7.84E−11 | −9.27E−12 | 8.39E−13 | 2.05E−12 |

D

| ASPH | 3L10R1 | 3L10R2 |
|---|---|---|
| Radius | −97.90 | −12.89 |
| Conic | 0.00 | −0.20 |
| 4TH | 0.00E+00 | 2.62E−05 |
| 6TH | 0.00E+00 | 7.73E−08 |
| 8TH | 0.00E+00 | −2.11E−10 |
| 10th | 0.00E+00 | 3.56E−12 |

The ultra short throw projection lens 30A and 30B uses a first wavelength λ1 of 650 nm, a second wavelength λ2 of 540 nm and a third wavelength λ3 of 450 nm to simulate different transverse ray fan plot as shown in FIG. 3C, and the image source IMA presents different image heights of 0.5840 mm, 1.6500 mm, 3.2990 mm, 4.9490 mm, 6.5990 mm and 8.2490 mm respectively. The symbols ey, py, ex and px respectively represent the y-axis lateral aberration, y-axis pupil height, X-axis lateral aberration, x-axis pupil height, wherein maximum scale is ±20.000 um, the generated aberration value is controlled within the range of −20 um˜12 um; The field curvature diagram in FIG. 3D has a maximum field of view of 71.899 degrees, curves T and S are respectively the tangential field curvature characteristic curve and the sagittal field curvature characteristic curve, the tangential field curvature value and sagittal field curvature value are controlled within the range of −0.04 mm˜0.04 mm; The distortion diagram in FIG. 3E has a maximum field of view of 71.899 degrees, and the distortion amount is controlled within the range of 0˜6%; The lateral color aberration diagram in FIG. 3F has a maximum field of view of 8.2490 mm, and using a wavelength of about 0.54 microns as a reference, the lateral color aberration value is controlled within the range of −2.0 um˜3 um.

With the features above disclosed, through the above simulation curves and data, it can prove that the present invention can meet the requirement for shortening the projection distance, and at the same time, the aberrations, field curvature, distortion and lateral color aberration of the ultra short throw projection lenses 10A, 10B, 20A, 20B, 30A, and 30B can all be controlled within a small range; therefore, the present invention has the effect of shortening the projection distance while taking into account the quality of projection imaging.

Although particular embodiment of the invention has been described in detail for purposes of illustration, various modifications and enhancements may be made without departing from the spirit and scope of the invention. Accordingly, the invention is not to be limited except by the appended claims.

What is claimed is:

1. An ultra short throw projection lens, includes a first lens group 11 and a second lens group 22, the image source IMA is first projected into an intermediate image by the second lens group 22, then the intermediate image is projected into a final image on the screen side by the first lens group 11, which complies with 0.23≤TR≤0.45 and 1.6≤|IMH2|/|IMH1|≤3, TR is the throw ratio of the ultra-short throw projection lens, IMH1 is the maximum image height of the image source, IMH2 is the maximum image height of the intermediate image, the second lens group includes an aperture A, and the aperture A has an F/# between 1.6˜3.2.

2. The ultra short throw projection lens as claimed in claim 1, wherein the focal length of the first lens group 11 is F1, which complies with 2.3≤F1/TR/|IMH1|≤3.5.

3. The ultra short throw projection lens as claimed in claim 1, wherein the first lens group 11 includes a first aspherical lens with a concave surface facing the image source side, and a second aspherical lens with a concave surface facing the imaging side.

4. The ultra short throw projection lens as claimed in claim 3, wherein the first aspherical lens is a convex-concave lens or a biconcave lens, complies with 1≤CA*TR/|IMH1|≤2.1, where CA is the effective diameter of the imaging side of the first aspherical lens; the second aspherical lens is a concave-convex lens or convex-concave lens.

5. The ultra short throw projection lens as claimed in claim 1, wherein the focal length of the second lens group 22 is F2, which complies with 70≤|F2|≤300.

6. The ultra short throw projection lens as claimed in claim 1, wherein the Vd of the last lens of the second lens group close to the image source is between 16˜25.

7. The ultra short throw projection lens as claimed in claim 1, wherein the ultra short throw projection lens complies with 6≤ASP*F/#≤10, where ASP is the total number of aspheric lenses of the ultra short throw projection lens.

8. The ultra short throw projection lens as claimed in claim 1, wherein the ultra short throw projection lens complies with 110≤FOV≤155, and FOV is the maximum field of view angle of the ultra short throw projection lens.

9. The ultra short throw projection lens as claimed in claim 1, wherein the ultra short throw projection lens further includes a reflective element located between the first lens group and the second lens group for changing the direction of the optical axis.
